(19) United States
(12) Patent Application Publication
(10) Pub. No.: US 2026/0197240 A1
(43) Pub. Date: Jul. 9, 2026

(54) CENTRAL OFFICE DEVICE AND BANDWIDTH ALLOCATION METHOD

(71) Applicant: REALTEK SEMICONDUCTOR CORPORATION, HSINCHU (TW)

(72) Inventor: ZHI-YONG TANG, Suzhou (CN)

(21) Appl. No.: 19/413,247

(22) Filed: Dec. 9, 2025

(30) Foreign Application Priority Data
Jan. 8, 2025 (CN) 202510028438.9

(51) Int. Cl. H04L 41/0896; H04L 5/00

(52) U.S. Cl. CPC H04L 41/0896; H04L 5/0064

(57) ABSTRACT

A central office device includes a feedback circuit and a bandwidth allocation circuit. The feedback circuit is configured to receive a buffer size signal from a terminal device, and perform a feedback process on the buffer size signal to generate a feedback signal. The bandwidth allocation circuit is configured to provide a bandwidth to the terminal device according to the feedback signal.

### BACKGROUND OF THE INVENTION

### Field of the Invention

The present disclosure relates to a central office device and a bandwidth allocation method especially to a central office device and a bandwidth allocation method that utilize a feedback circuit to provide a suitable bandwidth so as to efficiently complete transmission of all buffered data in a terminal device.

### Description of Related Art

In a Gigabit-Capable Passive Optical Network (GPON), a terminal device (e.g., optical network unit, ONU) periodically reports to a central office device (e.g., optical line termination, OLT) the amount of buffered data (e.g., the amount of data to be transmitted) in the buffer of the terminal device. The central office device then allocates bandwidth to the terminal device based on the amount of buffered data, so that the terminal device can transmit the buffered data.

However, there exists a time difference between the time point when the terminal device reports the amount of buffered data and the time point when the terminal device actually obtains bandwidth. During this time difference, newly added buffered data cannot be transmitted using the actually obtained bandwidth, thereby making residual buffered data continuously remain in the buffer of the terminal device.

### SUMMARY OF THE INVENTION

In some aspects, an object of the present disclosure is to, but not limited to, provide a central office device and a bandwidth allocation method that makes an improvement to the prior art.

An embodiment of a central office device includes a feedback circuit and a bandwidth allocation circuit. The feedback circuit is configured to receive a buffer size signal from a terminal device, and perform a feedback process on the buffer size signal to generate a feedback signal. The bandwidth allocation circuit is configured to provide a bandwidth to the terminal device according to the feedback signal.

An embodiment of a bandwidth allocation method of the present disclosure, applied to a central office device, includes following steps: receiving a buffer size signal from a terminal device, and performing a feedback process on the buffer size signal to generate a feedback signal by a feedback circuit of the central office device; and providing a bandwidth to the terminal device according to the feedback signal by a bandwidth allocation circuit of the central office device.

Technical features of some embodiments of the present disclosure make an improvement to the prior art. The central office device and the bandwidth allocation method of the present disclosure utilize a feedback circuit to provide a suitable bandwidth to the terminal device, thereby efficiently completing the transmission of all buffered data in the terminal device and avoiding residual data remaining in the buffer of the terminal device.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a central office device and a terminal device of the present disclosure.

FIG. 2 shows an embodiment of a flow diagram of a bandwidth allocation method of the present disclosure.

FIG. 3 shows an embodiment of a central office device of the present disclosure.

FIG. 4 shows an embodiment of a relationship between bandwidth and time of the present disclosure.

FIG. 5 shows an embodiment of a relationship between accumulated total amount of buffered data and time of the present disclosure.

FIG. 6 shows an embodiment of a relationship between amount of residual buffered data and time of the present disclosure.

FIG. 7 shows an embodiment of a feedback circuit of the central office device as shown in FIG. 1 of the present disclosure.

### DETAILED DESCRIPTION OF THE PREFERRED EMBODIMENTS

To address the issue that residual buffered data continuously remains in the buffer of the terminal device, the present disclosure provides a central office device and a bandwidth allocation method, which are described in detail below.

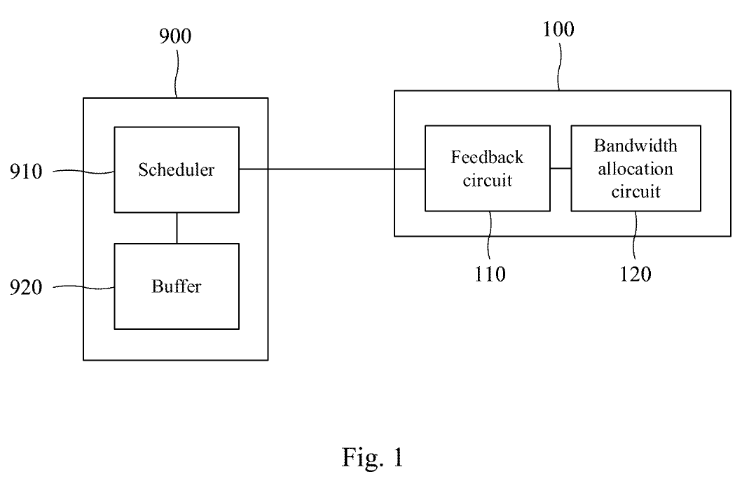

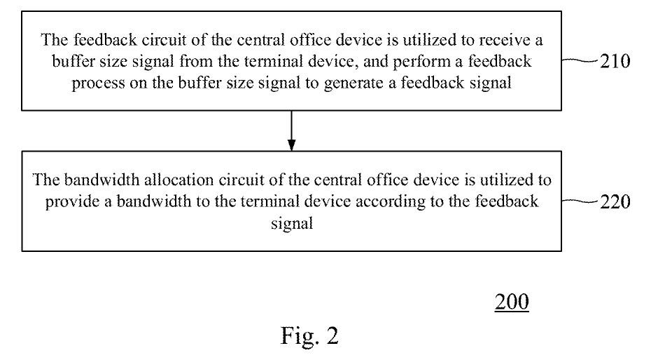

FIG. 1 shows an embodiment of a central office device 100 and a terminal device 900 of the present disclosure. As shown in the figure, the central office device 100 includes a feedback circuit 110 and a bandwidth allocation circuit 120, and the terminal device 900 includes a scheduler 910 and a buffer 920. To facilitate understanding of the operation of the central office device 100, please also refer to FIG. 2. FIG. 2 shows an embodiment of a flow diagram of a bandwidth allocation method 200 of the present disclosure.

Referring to FIG. 1 and FIG. 2, in step 210, the feedback circuit 110 of the central office device 100 is utilized to receive a buffer size signal from the terminal device 900, and perform a feedback process on the buffer size signal to generate a feedback signal. For example, the scheduler 910 of the terminal device 900 may obtain the size of buffered data from the buffer 920, and transmit the buffer size signal to the feedback circuit 110 accordingly. Subsequently, the feedback circuit 110 receives the buffer size signal transmitted from the terminal device 900, and performs the feedback process on the buffer size signal to generate the feedback signal.

In step 220, the bandwidth allocation circuit 120 of the central office device 100 is utilized to provide a bandwidth to the terminal device 900 according to the feedback signal. For example, the bandwidth allocation circuit 120 receives the feedback signal transmitted from the feedback circuit 110. Subsequently, the bandwidth allocation circuit 120 provides a suitable bandwidth to the terminal device 900 according to the feedback signal, thereby efficiently completing the transmission of all buffered data in the buffer 920 of the terminal device 900 and avoiding (e.g., clearing or reducing) residual data remaining in the buffer 920 of the terminal device 900.

Compared with the prior art, which directly uses the buffer size signal of the terminal device 900 as a basis for allocating bandwidth, the central office device 100 and the bandwidth allocation method 200 of the present disclosure utilize the feedback circuit 110 to further perform the feedback process on the buffer size signal of the terminal device 900 to generate the feedback signal, and then the bandwidth allocation circuit 120 provides a suitable bandwidth according to the feedback signal, thereby efficiently completing the transmission of all buffered data in the buffer 920 of the terminal device 900. The detailed description will be provided below.

In some embodiments, the central office device 100 and the terminal device 900 of the present disclosure may be applied to a Gigabit-Capable Passive Optical Network (GPON). The central office device 100 may be an Optical Line Termination (OLT), and the terminal device 900 may be an Optical Network Unit (ONU). The buffer size signal may include (or be) a transmitter buffer size.

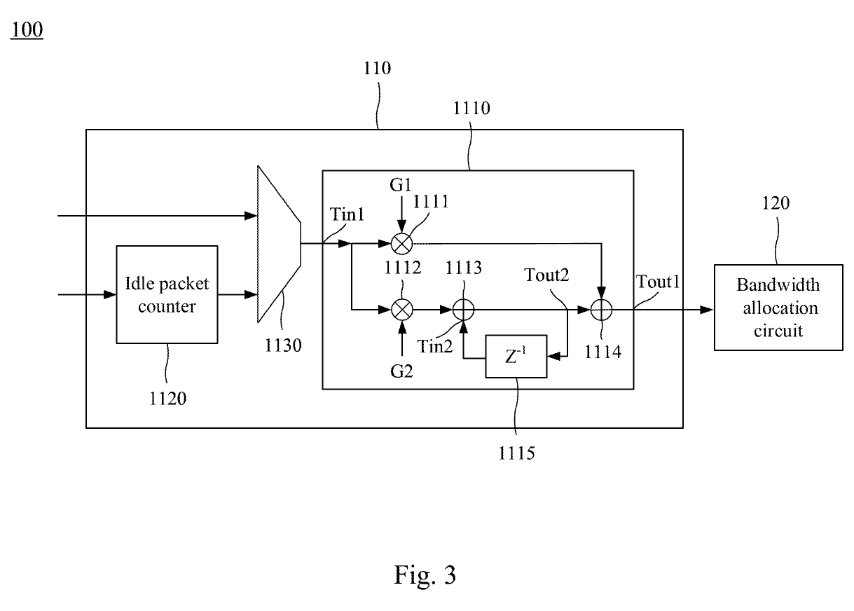

FIG. 3 shows an embodiment of a central office device 100 of the present disclosure. As shown in the figure, the feedback circuit 110 includes a loop filter 1110. The loop filter 1110 is configured to receive a buffer size signal from the terminal device 900, perform a filtering process on the buffer size signal to generate a feedback signal, and output the feedback signal to the bandwidth allocation circuit 120. For example, the scheduler 910 of the terminal device 900 may obtain the size of buffered data from the buffer 920, and transmit the buffer size signal to the loop filter 1110 accordingly. Subsequently, the loop filter 1110 receives the buffer size signal transmitted from the terminal device 900, performs the filtering process on the buffer size signal to generate the feedback signal, and outputs the feedback signal to the bandwidth allocation circuit 120.

In some embodiments, the loop filter 1110 of the feedback circuit 110 includes a first multiplier 1111, a second multiplier 1112, a first adder 1113, a second adder 1114, and an integrator 1115. The second multiplier 1112 and the first multiplier 1111 are coupled to a first input terminal Tin1 of the loop filter 1110 of the feedback circuit 110. The first adder 1113 is coupled to the second multiplier 1112. The second adder 1114 is coupled to the first multiplier 1111, the first adder 1113, and a first output terminal Tout1 of the loop filter 1110 of the feedback circuit 110. The integrator 1115 is coupled between a second input terminal Tin2 and a second output terminal Tout2 of the first adder 1113.

In some embodiments, the first multiplier 1111 is configured to perform a multiplication calculation on the buffer size signal according to a first parameter G1 to generate a first multiplication result. The second multiplier 1112 is configured to perform the multiplication calculation on the buffer size signal according to a second parameter G2 to generate a second multiplication result. The integrator 1115 first receives the second multiplication result from the second multiplier 1112 via the first adder 1113, and then performs an integral calculation on the second multiplication result to generate an integrated feedback result. The first adder 1113 is configured to perform an addition calculation on the second multiplication result transmitted from the second multiplier 1112 and the integrated feedback result fed back from the integrator 1115 to generate a first addition result. The second adder 1114 is configured to perform the addition calculation on the first multiplication result and the first addition result to generate a second addition result as the feedback signal, and output the feedback signal to the bandwidth allocation circuit 120.

As described above, the loop filter 1110 of the present disclosure may lock the bandwidth through the buffer size, and its principle is similar to that of a phase-locked loop (PLL). The buffer size in the present disclosure is similar to the phase used in PLL applications. In addition, the bandwidth (e.g., ingress rate) in the present disclosure is similar to the frequency in PLL applications. A PLL locks the frequency through the phase, where the phase is the integral of the frequency over time, and the PLL allows the phase error to approach zero. Similarly, the loop filter 1110 of the present disclosure locks the bandwidth (e.g., ingress rate) through the buffer size. The buffer size is the integral of the bandwidth (e.g., ingress rate) over time, and the loop filter 1110 of the present disclosure likewise allows the buffered data in the buffer 920 of the terminal device 900 to approach zero. The loop filter 1110 of the present disclosure may process the buffer size to provide a suitable bandwidth to the terminal device 900, thereby efficiently completing the transmission of all buffered data in the buffer 920 of the terminal device 900 and avoiding residual data remaining in the buffer 920 of the terminal device 900.

In some embodiments, the first parameter G1 is greater than the second parameter G2. For example, the first parameter G1 and the second parameter G2 are used to adjust the speed of tracking the bandwidth (e.g., ingress rate), where the first parameter G1 may be set to 1, and the second parameter G2 may be set to 0.25. However, the present disclosure is not limited to the above embodiments, which are merely configured to illustratively describe one of the implementations of the present disclosure. In other embodiments, the first parameter G1 and the second parameter G2 of the present disclosure may adopt other suitable values depending on actual requirements.

In some embodiments, when the bandwidth includes a fixed bandwidth, the loop filter 1110 of the feedback circuit 110 includes a first-order loop filter. For example, if the bandwidth provided by the bandwidth allocation circuit 120 to the terminal device 900 is the fixed bandwidth, for example, the bandwidth provided by the bandwidth allocation circuit 120 to the terminal device 900 is 80 MB/s, the loop filter 1110 may adopt a first-order loop filter. In addition, if the bandwidth allocation circuit 120 provides different bandwidths to the terminal device 900 at intervals, for example, the bandwidth allocation circuit 120 provides 80 MB/s to the terminal device 900 during a first period (e.g., 1 millisecond (ms)), and provides 240 MB/s to the terminal device 900 during a second period (e.g., 1.5 milliseconds), the loop filter 1110 may still adopt a first-order loop filter.

In some embodiments, the feedback circuit 110 includes an idle packet counter 1120. The idle packet counter 1120 is configured to receive at least one idle packet from the terminal device 900, and calculate an idle signal according to a quantity of the at least one idle packet. The loop filter 1110 is configured to receive the idle signal or the buffer size signal, perform a filtering process on the idle signal or the buffer size signal to generate a feedback signal, and output the feedback signal to the bandwidth allocation circuit 120.

For example, in prior art, the buffer size reported by the terminal device 900 is always greater than or equal to zero. If the bandwidth allocation circuit 120 allocates excessive bandwidth to the terminal device 900, the terminal device 900 still reports a buffer size greater than or equal to zero, which causes the bandwidth allocation circuit 120 to continue allocating excessive bandwidth. To address this problem, the central office device 100 of the present disclosure is further equipped with an idle packet counter 1120. If the bandwidth allocation circuit 120 allocates excessive bandwidth to the terminal device 900, after the terminal device 900 completely transmits the buffered data in the buffer 920, the terminal device 900 starts transmitting idle packets. The idle packet counter 1120 counts the number of idle packets, and reports an idle value lower than zero (e.g., a negative number) to the loop filter 1110. The loop filter 1110 then performs a filtering process on the idle value (e.g., the negative value) to generate a feedback signal. When the bandwidth allocation circuit 120 receives the feedback signal, it can determine that excessive bandwidth has been allocated to the terminal device 900, and accordingly provides a smaller bandwidth to the terminal device 900. After each idle value is reported, the idle packet counter 1120 clears its counter value in preparation for the next counting operation.

In some embodiments, the feedback circuit 110 includes a multiplexer 1130. The multiplexer 1130 is configured to receive the buffer size signal from the terminal device 900, receive the idle signal from the idle packet counter 1120, and provide the idle signal or the buffer size signal to the loop filter 1110.

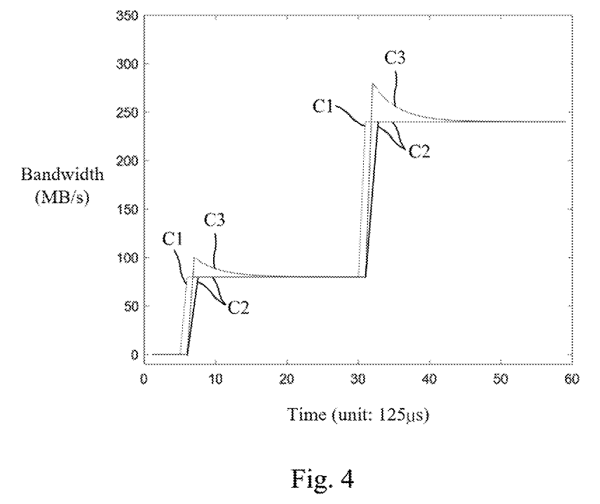

FIG. 4 shows an embodiment of a relationship between bandwidth and time of the present disclosure. As shown in the figure, curve C1 represents the actual required bandwidth of the terminal device 900. Curve C2 represents the bandwidth provided by the central office device 100 in the prior art to the terminal device 900. As can be seen from the figure, there is always a time difference between the bandwidth provided by the central office device 100 in the prior art to the terminal device 900 and the actual required bandwidth of the terminal device 900. During this time difference, newly added buffer data cannot be transmitted using the allocated bandwidth, which results in residual buffered data remaining in the buffer 920 of the terminal device 900.

In some embodiments, curve C3 represents the bandwidth provided by the central office device 100 of the present disclosure to the terminal device 900. As can be seen from the figure, the bandwidth allocation circuit 120 of the central office device 100 is capable of detecting a bandwidth variation of the bandwidth, and providing the bandwidth and an additional bandwidth to the terminal device 900 during an initial period of the bandwidth variation. For example, if the bandwidth variation includes a bandwidth increase, such as an increase from 0 to 80 MB/s, the bandwidth allocation circuit 120 provides the bandwidth plus the additional bandwidth to the terminal device 900 during the initial period of the bandwidth variation, thereby efficiently completing the transmission of all buffered data in the terminal device 900 and avoiding residual data in the buffer 920 of the terminal device 900.

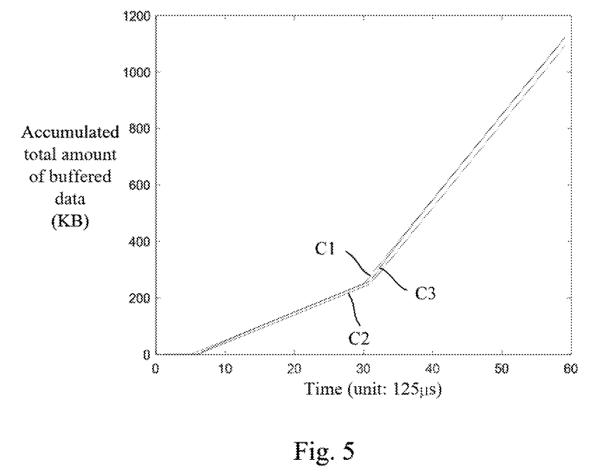

FIG. 5 shows an embodiment of a relationship between accumulated total amount of buffered data and time of the present disclosure. As shown in the figure, curve C1 represents the actual accumulated total amount of buffered data in the buffer 920 of the terminal device 900. Curve C2 represents the accumulated total amount of buffered data transmitted by the terminal device 900 in the prior art. As can be seen from the figure, the accumulated total amount of buffered data transmitted by the terminal device 900 in the prior art consistently lags behind the actual accumulated total amount of buffered data in the buffer 920 of the terminal device 900, thereby resulting in residual buffered data remaining in the buffer 920 of the terminal device 900.

In some embodiments, curve C3 represents the accumulated total amount of buffered data transmitted by the terminal device 900 of the present disclosure. As can be seen from the figure, the accumulated total amount of buffered data transmitted by the terminal device 900 is almost the same as the actual accumulated total amount of buffered data in the buffer 920 of the terminal device 900, thereby efficiently completing the transmission of all buffered data in the terminal device 900 and avoiding residual data in the buffer 920 of the terminal device 900.

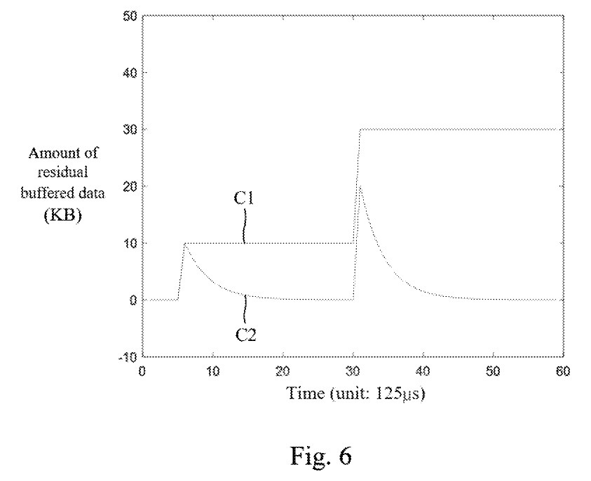

FIG. 6 shows an embodiment of a relationship between amount of residual buffered data and time of the present disclosure. As shown in the figure, curve C1 represents the actual amount of residual buffered data in the buffer 920 of the terminal device 900 in the prior art (indicating that the allocated bandwidth is insufficient to transmit all data in the buffer). As can be seen from the figure, the buffer 920 of the terminal device 900 in the prior art always contains residual buffered data.

In some embodiments, curve C2 represents the actual amount of residual buffered data in the buffer 920 of the terminal device 900 of the present disclosure. As can be seen from the figure, the buffered data in the terminal device 900 can be efficiently and completely transmitted, thereby avoiding residual data in the buffer 920 of the terminal device 900.

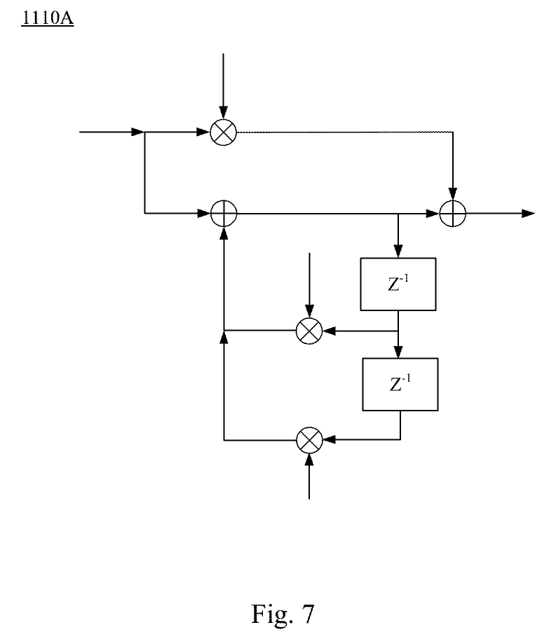

FIG. 7 shows an embodiment of a loop filter 1110 of the central office device 100 as shown in FIG. 3 of the present disclosure. As shown in the figure, if the bandwidth of the central office device 100 includes a time-varying bandwidth, the loop filter 1110A of the central office device 100 may be a second-order loop filter. For example, when the bandwidth (e.g., ingress rate) is time-varying, such as the bandwidth (e.g., ingress rate) being K×t (i.e., the bandwidth increases gradually with time t), it is only necessary to upgrade the loop filter 1110A to a second-order loop filter (e.g., the second-order loop filter shown in FIG. 7), so that the bandwidth allocation circuit 120 can provide a suitable bandwidth, thereby efficiently completing the transmission of all buffered data in the terminal device 900 and avoiding residual data in the buffer 920 of the terminal device 900. In addition, when the bandwidth (e.g., ingress rate) is time-varying, such as the bandwidth (e.g., ingress rate) being K×t² (i.e., the bandwidth increases as a power of time), it is only necessary to upgrade the order of the loop filter 1110A to a third-order loop filter, which can likewise enable the bandwidth allocation circuit 120 to provide a suitable bandwidth, thereby efficiently completing the transmission of all buffered data in the terminal device 900 and avoiding residual data in the buffer 920 of the terminal device 900.

It should be noted that the present disclosure is not limited to the embodiments as shown in FIG. 1 to FIG. 7, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The central office device 100 and the bandwidth allocation method 200 of the present disclosure utilize the feedback circuit 110 to provide a suitable bandwidth to the terminal device 900, thereby efficiently completing the transmission of all buffered data in the terminal device 900 and avoiding residual data remaining in the buffer 920 of the terminal device 900.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A central office device, comprising:
a feedback circuit, configured to receive a buffer size signal from a terminal device, and perform a feedback process on the buffer size signal to generate a feedback signal; and
a bandwidth allocation circuit, configured to provide a bandwidth to the terminal device according to the feedback signal.

2. The central office device of claim 1, wherein the feedback circuit comprises:
a loop filter, configured to receive the buffer size signal from the terminal device, perform a filtering process on the buffer size signal to generate the feedback signal, and output the feedback signal to the bandwidth allocation circuit.

3. The central office device of claim 1, wherein the feedback circuit comprises:
a first multiplier;
a second multiplier, coupled to a first input terminal of the feedback circuit along with the first multiplier;
a first adder, coupled to the second multiplier;
a second adder, coupled to the first multiplier, the first adder, and a first output terminal of the feedback circuit; and
an integrator, coupled between a second input terminal and a second output terminal of the first adder.

4. The central office device of claim 1, wherein the feedback circuit comprises:
a first multiplier, configured to perform a multiplication calculation on the buffer size signal according to a first parameter to generate a first multiplication result;
a second multiplier, configured to perform the multiplication calculation on the buffer size signal according to a second parameter to generate a second multiplication result;
an integrator, configured to perform an integral calculation on the second multiplication result to generate an integrated feedback result;
a first adder, configured to perform an addition calculation on the second multiplication result and the integrated feedback result to generate a first addition result; and
a second adder, configured to perform the addition calculation on the first multiplication result and the first addition result to generate a second addition result as the feedback signal, and output the feedback signal to the bandwidth allocation circuit.

5. The central office device of claim 4, wherein the first parameter is greater than the second parameter.

6. The central office device of claim 1, wherein when the bandwidth comprises a fixed bandwidth, the feedback circuit comprises a first-order loop filter, wherein when the bandwidth comprises a time-varying bandwidth, the feedback circuit comprises a second-order loop filter.

7. The central office device of claim 2, wherein the feedback circuit comprises:
an idle packet counter, configured to receive at least one idle packet from the terminal device, and calculate an idle signal according to a quantity of the at least one idle packet;
wherein the loop filter is configured to receive the idle signal or the buffer size signal, perform the filtering process on the idle signal or the buffer size signal to generate the feedback signal, and output the feedback signal to the bandwidth allocation circuit.

8. The central office device of claim 7, wherein the feedback circuit comprises:
a multiplexer, configured to receive the buffer size signal from the terminal device, receive the idle signal from the idle packet counter, and provide the idle signal or the buffer size signal to the loop filter.

9. The central office device of claim 1, wherein the bandwidth allocation circuit is configured to detect a bandwidth variation of the bandwidth, and provide the bandwidth and an additional bandwidth to the terminal device during an initial period of the bandwidth variation.

10. The central office device of claim 9, wherein when the bandwidth variation comprises a bandwidth increase, the bandwidth allocation circuit is configured to provide the bandwidth and the additional bandwidth to the terminal device during the initial period of the bandwidth variation.

11. A bandwidth allocation method, applied to a central office device, comprising:
receiving a buffer size signal from a terminal device, and performing a feedback process on the buffer size signal to generate a feedback signal by a feedback circuit of the central office device; and
providing a bandwidth to the terminal device according to the feedback signal by a bandwidth allocation circuit of the central office device.

12. The bandwidth allocation method of claim 11, wherein the feedback circuit comprises a loop filter, wherein receiving the buffer size signal from the terminal device, and performing the feedback process on the buffer size signal to generate the feedback signal by the feedback circuit of the central office device comprises:
receiving the buffer size signal from the terminal device, performing a filtering process on the buffer size signal to generate the feedback signal, and outputting the feedback signal to the bandwidth allocation circuit by the loop filter.

13. The bandwidth allocation method of claim 11, wherein receiving the buffer size signal from the terminal device, and performing the feedback process on the buffer size signal to generate the feedback signal by the feedback circuit of the central office device comprises:
performing a multiplication calculation on the buffer size signal according to a first parameter to generate a first multiplication result by a first multiplier of the feedback circuit;
performing the multiplication calculation on the buffer size signal according to a second parameter to generate a second multiplication result by a second multiplier of the feedback circuit;
performing an integral calculation on the second multiplication result to generate an integrated feedback result by an integrator of the feedback circuit;
performing an addition calculation on the second multiplication result and the integrated feedback result to generate a first addition result by a first adder of the feedback circuit; and
performing the addition calculation on the first multiplication result and the first addition result to generate a second addition result as the feedback signal, and outputting the feedback signal to the bandwidth allocation circuit by a second adder of the feedback circuit.

14. The bandwidth allocation method of claim 13, wherein the first parameter is greater than the second parameter.

15. The bandwidth allocation method of claim 11, wherein when the bandwidth comprises a fixed bandwidth, the feedback circuit comprises a first-order loop filter, wherein when the bandwidth comprises a time-varying bandwidth, the feedback circuit comprises a second-order loop filter.

16. The bandwidth allocation method of claim 12, further comprising:
receiving at least one idle packet from the terminal device, and calculating an idle signal according to a quantity of the at least one idle packet by an idle packet counter of the feedback circuit.

17. The bandwidth allocation method of claim 16, wherein receiving the buffer size signal from the terminal device, performing the filtering process on the buffer size signal to generate the feedback signal, and outputting the feedback signal to the bandwidth allocation circuit by the loop filter comprises:
receiving the idle signal or the buffer size signal, performing the filtering process on the idle signal or the buffer size signal to generate the feedback signal, and outputting the feedback signal to the bandwidth allocation circuit by the loop filter.

18. The bandwidth allocation method of claim 17, further comprising:
receiving the buffer size signal from the terminal device, receiving the idle signal from the idle packet counter, and providing the idle signal or the buffer size signal to the loop filter by a multiplexer of the feedback circuit.

19. The bandwidth allocation method of claim 11, further comprising:
detecting a bandwidth variation of the bandwidth by the bandwidth allocation circuit of the central office device; and
providing the bandwidth and an additional bandwidth to the terminal device during an initial period of the bandwidth variation by the bandwidth allocation circuit of the central office device.

20. The bandwidth allocation method of claim 19, wherein when the bandwidth variation comprises a bandwidth increase, providing the bandwidth and the additional bandwidth to the terminal device during the initial period of the bandwidth variation by the bandwidth allocation circuit of the central office device comprises:
providing the bandwidth and the additional bandwidth to the terminal device during the initial period of the bandwidth variation by the bandwidth allocation circuit of the central office device.
